(19) United States
(12) Patent Application Publication
(10) Pub. No.: US 2025/0251960 A1
(43) Pub. Date: Aug. 7, 2025

(54) SYSTEMS, METHODS, AND APPARATUS FOR CONTROLLING CONTEXT SWITCHING BASED ON VIRTUALIZED APPLICATIONS

(71) Applicant: Samsung Electronics Co., Ltd., Suwon-si (KR)

(72) Inventors: Da ZHANG, Fremont, CA (US); Tong ZHANG, Fremont, CA (US); Rekha PITCHUMANI, Oak Hill, VA (US); Yang Seok KI, Palo Alto, CA (US)

(21) Appl. No.: 18/796,288

(22) Filed: Aug. 6, 2024

Related U.S. Application Data
(60) Provisional application No. 63/550,027, filed on Feb. 5, 2024.

(51) Int. Cl. G06F 9/455

(52) U.S. Cl. CPC G06F 9/45558

(57) ABSTRACT

Provided are systems, methods, and apparatuses for controlling context switching based on monitoring virtualized applications. In one or more examples, the systems, devices, and methods include receiving, at a virtual machine controller and from a system profiler, a watchpoint condition; determining a number of times the watchpoint condition is detected based on implementing the watchpoint condition on an application and executing the application; determining the number of times the watchpoint condition is detected satisfies a watchpoint threshold having a value of greater than or equal to two; and based on satisfying the watchpoint threshold, pausing execution of the application and giving control of the application to the system profiler.

### CROSS-REFERENCE TO RELATED APPLICATIONS

This application claims the benefit of U.S. Provisional Patent Application Ser. No. 63/550,027, filed Feb. 5, 2024, which is incorporated by reference herein for all purposes.

### TECHNICAL FIELD

The disclosure relates generally to memory systems, and more particularly to controlling context switching based on monitoring virtualized applications.

### BACKGROUND

The present background section is intended to provide context only, and the disclosure of any concept in this section does not constitute an admission that said concept is prior art.

Application profiling can help developers monitor an application's performance under different conditions to identify areas for improvement. Profiling can help developers optimize application performance and reduce the number of problems that may arise later in development. Application profiling can help determine processor compatibility with architecture and capacity, memory impact across cache, system, and hard storage, battery impact across different usage patterns, and the like.

### SUMMARY

In various embodiments, the systems and methods described herein include systems, methods, and apparatuses for controlling context switching based on monitoring virtualized applications. In some aspects, the techniques described herein relate to a method including: receiving, at a virtual machine controller and from a system profiler, a watchpoint condition; determining a number of times the watchpoint condition is detected based on implementing the watchpoint condition on an application and executing the application; determining the number of times the watchpoint condition is detected satisfies a watchpoint threshold having a value of greater than or equal to two; and based on satisfying the watchpoint threshold, pausing execution of the application and giving control of the application to the system profiler.

In some aspects, the techniques described herein relate to a method, further including receiving from the system profiler a pathname of the application, wherein executing the application is based on receiving the pathname of the application.

In some aspects, the techniques described herein relate to a method, further including receiving a value of the watchpoint threshold from the system profiler.

In some aspects, the techniques described herein relate to a method, further including setting a value of the watchpoint threshold to a default value based on receiving the watchpoint condition from the system profiler.

In some aspects, the techniques described herein relate to a method, wherein executing the application is based on receiving control of the application from the system profiler.

In some aspects, the techniques described herein relate to a method, wherein the virtual machine controller includes at least one of a kernel or a hypervisor.

In some aspects, the techniques described herein relate to a method, wherein the kernel includes a guest kernel of a virtual machine.

In some aspects, the techniques described herein relate to a method, wherein executing the application includes executing a virtualized application on a virtual machine, the virtual machine being created by the virtual machine controller.

In some aspects, the techniques described herein relate to a method, wherein the system profiler includes a computer architecture simulator that executes on a host system of the virtual machine.

In some aspects, the techniques described herein relate to a device including: at least one memory; and at least one processor coupled with the at least one memory configured to: receive, at a virtual machine controller of the device and from a system profiler, a watchpoint condition; determine a number of times the watchpoint condition is detected based on implementing the watchpoint condition on an application and executing the application; determine the number of times the watchpoint condition is detected satisfies a watchpoint threshold having a value of greater than or equal to two; and based on satisfying the watchpoint threshold, pause execution of the application and give control of the application to the system profiler.

In some aspects, the techniques described herein relate to a device, wherein the at least one processor is configured to receive from the system profiler a pathname of the application, wherein executing the application is based on receiving the pathname of the application.

In some aspects, the techniques described herein relate to a device, wherein the at least one processor is configured to receive a value of the watchpoint threshold from the system profiler.

In some aspects, the techniques described herein relate to a device, wherein the at least one processor is configured to set a value of the watchpoint threshold to a default value based on receiving the watchpoint condition from the system profiler.

In some aspects, the techniques described herein relate to a device, wherein executing the application is based on receiving control of the application from the system profiler.

In some aspects, the techniques described herein relate to a device, wherein the virtual machine controller includes at least one of a kernel or a hypervisor.

In some aspects, the techniques described herein relate to a device, wherein the kernel includes a guest kernel of a virtual machine.

In some aspects, the techniques described herein relate to a non-transitory computer-readable medium storing code that includes instructions executable by a processor to: receive, at a virtual machine controller and from a system profiler, a watchpoint condition; determine a number of times the watchpoint condition is detected based on implementing the watchpoint condition on an application and executing the application; determine the number of times the watchpoint condition is detected satisfies a watchpoint threshold having a value of greater than or equal to two; and based on satisfying the watchpoint threshold, pause execution of the application and give control of the application to the system profiler.

In some aspects, the techniques described herein relate to a non-transitory computer-readable medium, wherein the code includes further instructions executable by the processor to cause the processor to receive from the system profiler a pathname of the application, wherein executing the application is based on receiving the pathname of the application.

In some aspects, the techniques described herein relate to a non-transitory computer-readable medium, wherein the code includes further instructions executable by the processor to cause the processor to receive a value of the watchpoint threshold from the system profiler.

In some aspects, the techniques described herein relate to a non-transitory computer-readable medium, wherein the code includes further instructions executable by the processor to cause the processor to set a value of the watchpoint threshold to a default value based on receiving the watchpoint condition from the system profiler.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The systems and methods described herein include multiple advantages and benefits. For example, the systems and methods may save context switching time and/or speed up application execution. Some embodiments may provide dynamic instrumentation, for example, with hypervisor and/or guest kernel assist to improve system performance. The systems and methods may provide edge profiling that improves system performance and decreases latency. The systems and methods may be configured to work with one or more virtualized applications. The systems and methods may enable a user to implement one or more (e.g., unlimited) breakpoints. The systems and methods may reduce or eliminate context switch and/or cache update costs. Some embodiments may be transparent to a program under debugging which, depending on the implementation details, may be suitable for security and/or code analysis. Some embodiments may operate without source code. The systems and methods may work with virtualized applications, for example, by using dynamic instrumentation support from a hypervisor and/or a guest kernel.

### BRIEF DESCRIPTION OF THE DRAWINGS

The above-mentioned aspects and other aspects of the present systems and methods will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings, wherein:

FIG. 1 illustrates an example system in accordance with one or more implementations as described herein.

FIG. 2 illustrates details of the system of FIG. 1, according to one or more implementations as described herein.

FIG. 3 illustrates an example system in accordance with one or more implementations as described herein.

FIG. 4 depicts a flow diagram illustrating an example method associated with the disclosed systems, in accordance with example implementations described herein.

FIG. 5 depicts a flow diagram illustrating an example method associated with the disclosed systems, in accordance with example implementations described herein.

FIG. 6 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some example embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Data processing may include data buffering, aligning incoming data from multiple communication lanes, forward error correction (FEC), etc. For example, data may be received by an analog front end (AFE), which can prepare the incoming data for digital processing. The digital portion of the transceivers (e.g., digital signal processor (DSP)) may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, SoC, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

The systems and methods described may be configured to minimize context switching. Context switching can involve stopping a current thread and executing another thread that is eligible to run. Context switching can happen for a number of reasons, such as when the current task is blocked or waiting. Context switching can have a cost in performance, due to running the task scheduler, translation lookaside buffer (TLB) flushes, sharing the CPU cache between multiple tasks, and so on. It is noted that a TLB can include a high-speed memory cache that stores recent translations of virtual memory to physical memory addresses.

In some cases, context switching can involve loading a corresponding process control block (PCB) stored in a PCB table in the kernel stack to retrieve information about the state of the new process. CPU state information including the registers, stack pointer, and program counter as well as memory management information like segmentation tables and page tables (unless the old process shares the memory with the new) may be loaded from the PCB for the new process. To avoid incorrect address translation in the case of the previous and current processes using different memory, the TLB may be flushed. Flushing the TLB can negatively affect performance as memory references to the TLB can result in a miss because the TLB would be empty after the context switch.

The systems and methods may be based on virtualization systems. Virtualization can include a computing technology that creates virtual representations of physical machines, such as servers, storage, and/or networks, on at least one physical machine. Virtualization may be performed based on using virtual software to mimic the functions of physical hardware and separate computing environments from physical infrastructure.

A virtual machine (VM) can include a software-based computer that behaves like a physical computer. VMs can run programs and operating systems, store data, connect to networks, and perform other computing functions. VMs can be thought of as virtual computers or software-defined computers within physical servers. In some cases, VMs may be partitioned from the rest of the system, so the software inside a VM is not permitted to interfere with a host computer's primary operating system. VMs created by virtualization can run in isolation from each other, allowing multiple workloads to run simultaneously and efficiently. A VM can have its own virtual resources, including CPU, memory, storage, network interfaces, and other devices. These virtual resources can be mapped to the real resources on the physical host computer.

A kernel may include a computer program that is the core of an operating system (OS) and manages the computer's hardware, operations, etc. The kernel may be the primary interface between the computer's hardware and the software running on it. Kernels may be one of the first programs loaded into memory before the boot loader. When a system starts up, the basic input/output system (BIOS) may complete hardware initialization, then run a bootloader that loads the kernel into a protected memory space. Once loaded, the BIOS may transfer control to the kernel, which then loads other OS components to complete the startup process.

In some examples, the systems and methods may be based on a guest kernel. A guest kernel may include a user-space executable kernel that runs inside a VM. A guest kernel may be used to create a VM, along with a root file system. The guest kernel may be passed to a hypervisor and used to boot the VM.

A hypervisor, also known as a virtual machine monitor (VMM) or virtualizer, can include a type of computer software, firmware, and/or hardware that creates and runs virtual machines. The term hypervisor can be a variant of “supervisor,” a term that can be used for the kernel of an operating system: the hypervisor can be considered the supervisor of the supervisors, with hyper-being used as a stronger variant of super-from “supervisor.” A computer on which a hypervisor runs one or more virtual machines can be referred to as a host machine, and each virtual machine can be referred to as a guest machine. The hypervisor presents the guest operating systems with a virtual operating platform and manages the execution of the guest operating systems. Unlike an emulator, the guest executes most instructions on the native hardware. Multiple instances of a variety of operating systems may share the virtualized hardware resources: for example, LINUX®, WINDOWS®, and MAC-OS® instances can all run on a single physical x86 machine. This contrasts with operating-system-level virtualization, where all instances (e.g. containers) may share a single kernel, though the guest operating systems can differ in user space, such as different Linux distributions with the same kernel.

In some cases, a hypervisor allows a single host computer to support multiple VMs by sharing resources, like memory and processing, etc. A hypervisor can do this by allocating the host server's compute, storage, and networking resources as needed by each VM. In some cases, a hypervisor enables virtualization of the compute and hardware resources of computers and servers, which can enable cloud computing. In some cases, the hypervisor isolates the hypervisor operating system and resources from the VMs, and enables the creation and management of those VMs. The VMs may not be aware their access to the hardware is virtualized, emulated, or protected from other users of the same hardware.

Edge computing can include a computing model that allows devices and local servers to process data near the user or at the edge of a network. Edge computing can be done on-site or near a data source. Edge computing can lead to faster and more efficient data processing, which can provide results in real-time. Edge computing can reduce latency and system costs. For example, when data is to be processed in a central data center, only the most important data may be transmitted in an edge computing system, which can minimize latency.

The systems and methods may be based on a profiler (e.g., system profiler, application profiler). In some cases, a profiler may include a computer architecture simulator (e.g., Gem5, ZSim, PTLsim, etc.). In some cases, the profiler may include a CPU simulation framework, a memory timing simulator, and/or an event-driven simulator (e.g., with multiple execution modes). Profilers may be used for research in computer systems, virtualization, cloud computing, etc. Profilers can include modular platforms that allow researchers to model computer hardware at the cycle level, including system-level architecture, processor microarchitecture, etc. Profilers can run Linux-based operating systems and/or full applications for multiple architectures, such as x86, RISC, etc. Profilers may operate in user-level mode, full-system mode, etc. In user-level mode, also known as system-call emulation mode, the simulator may execute user-level code without modeling the operating system. In full-system mode, the simulator may model an entire computing system, including memory, I/O subsystems, while running an unmodified operating system.

In some cases, the systems and methods may include a profiler performing virtual machine profiling, edge profiling, etc. Virtual machine profiling and/or edge profiling can be used to gather system data for virtual system performance analysis. Edge profiling can be used to optimize resources allocated to an edge to satisfy its constraints. For example, edge profiling can be used to profile edges of a virtual system to fine-tune the hardware resources allocated and used by an edge computing device. Virtual machine profiling can be used to optimize a virtual machine's allocated resources to meet its constraints. For example, virtual machine profiling can be used to profile virtual machines running on a virtual server platform to fine-tune the hardware resources allocated to and used by a virtual machine.

In some cases, the systems and methods may be based on instrumentation (e.g., dynamic instrumentation). For example, the systems and methods may include an instrumented application (e.g., instrumented virtualized application). In some cases, instrumentation may be limited by execution coverage. If a program never reaches a particular point of execution, then instrumentation relative to that point may collect no data. For instance, if a word processor application is instrumented, but the user never activates the print feature, then the instrumentation may have nothing to report regarding the routines which are used exclusively by the printing feature.

Static instrumentation may allow a program's files to be modified before the program runs. Dynamic instrumentation may use a dynamic process where it doesn't change the files. Thus, dynamic instrumentation can load the files of a program to memory and then modify the files to collect the instrumentation info. Dynamic instrumentation may include a technique that allows instrumentation points to be added, modified, and/or removed from a running application without disrupting the operation of the application. Dynamic instrumentation can be used to analyze and modify the behavior of an application at runtime by injecting instrumentation code. Dynamic instrumentation can enable developers and support teams to gain real-time insights into application behavior, rapidly identify and resolve issues, and minimize the impact on end-users. Dynamic instrumentation can allow instrumentation to be added to running production systems without restarts and at any location in the application code, including third-party libraries. Dynamic instrumentation can add or modify telemetry for logs, metrics, spans, corresponding tagging, etc.

In some cases, the systems and methods may be based on breakpoints and/or watchpoints. In software development, breakpoints and watchpoints may be features of debuggers that allow execution of software code to be paused at locations within the executed code or based on conditions resulting from the code (e.g., value of a variable, a function being called, etc.). When execution is stopped (e.g., based on a breakpoint or watchpoint), the contents of memory, registers, and/or variables may be determined. In some cases, when a condition of a breakpoint or watchpoint is satisfied, some programmed action may be performed before execution resumes. In some cases, a breakpoint may be triggered at a specified point in the execution of software code. In some cases, a watchpoint may be based on changes in the value of one or more variables associated with the execution of the program. In some implementations, a watchpoint may be based on the address of a data access that is being monitored rather than an instruction being executed. In some cases, watchpoints may be based on a global variable or a memory address being monitored. Watchpoints may be a type of breakpoint that is configured to monitor the value or address of a variable or expression and pause the execution of the program when the monitored value/address changes. In some cases, watchpoints may be referred to as data breakpoints (e.g., based on watchpoint being data dependent).

The systems and methods described may minimize or overcome the difficulties of implementing accurate and/or fast profiling when application source code is not available. Some embodiments may provide systems and methods that minimize or overcome potential issues resulting from a performance monitor unit being relatively fast but not relatively accurate. Some embodiments may provide systems and methods that minimize or overcome potential issues resulting from a central processing unit (CPU) debug register being relatively accurate but relatively slow (e.g., incurring significant slowdown) based on, for example, the computational costs of context switching. Context switching can be relatively expensive, for example, in terms of system resources, execution time, etc. Some embodiments may provide systems and methods that minimize or overcome potential issues where a pin tool may be relatively flexible but may not be able to attach to virtualized applications. Some embodiments may provide systems and methods with little or no disruption to an original application memory content, for example, after profiling is completed. Some embodiments may provide systems and methods that minimize or overcome potential issues where relatively slow speed may be encountered, for example, when a profiling watchpoint is inside a loop (e.g., a relatively tight and/or short loop).

In some embodiments, one or more elements may be indicated with initials, acronyms, abbreviations, and/or the like as follows: central processing unit (CPU), virtual CPU (vCPU), operating system (OS), and/or program counter (PC). In some example embodiments, an operating system may be implemented with Linux, a hypervisor may be implemented with a Kernel-based Virtual Machine (KVM), and/or a profiler and/or simulator may be implemented with Gem5, but other operating systems, hypervisors, profilers, and/or the like, may be used.

Some embodiments in accordance with example embodiments of the disclosure may implement profiling for virtualized applications which, depending on the implementation details, may provide fast and/or accurate profiling and/or may be implemented without source code. Some embodiments in accordance with example embodiments of the disclosure may implement an architecture to support one or more (e.g., an unlimited number) of debug registers.

Some embodiments in accordance with example embodiments of the disclosure may implement and/or provide one more of the following features and/or benefits: instrumentation (e.g., dynamic instrumentation), for example, with a hypervisor and/or guest kernel assist; edge profiling that may be relatively fast; and/or compatibility with a virtualized application. Depending on the implementation details, some embodiments may allow a user to perform edge profiling (e.g., perform edge profiling efficiently), allow a user to implement one or more (e.g., an unlimited number) of breakpoints, and/or eliminate one or more context switches and/or cache update costs. Some embodiments may be transparent to a program being debugged which, depending on the implementation details, may be suitable for security and/or code analysis.

In some examples, the systems and methods may pause the virtual processor and context switch to an external profiler when the guest kernel detects a watchpoint under a predefined condition (e.g., detect the watchpoint a set number of times). For example, the systems and methods may include the guest kernel allowing a context switch to a profiler when the guest kernel detects the watchpoint N times, where N is a positive integer (e.g., 2, 4, 8, 10, 15, 20, 25, 50, 100, etc.).

In some examples, the systems and methods described may be based on a watchpoint threshold. In some examples, the profiler may request that the guest kernel monitor an instrumented application in relation to the watchpoint threshold. For example, the systems and methods may include the guest kernel, allowing a context switch to a profiler when the guest kernel determines that the watchpoint threshold is satisfied. In some cases, the watchpoint threshold may be a positive integer value (e.g., based on positive integer N). The watchpoint threshold may be satisfied when the number of times the guest kernel detects the watchpoint is greater than (e.g., greater than or equal to) the watchpoint threshold. In some cases, the watchpoint threshold may be configured by a VM controller (e.g., a context controller of a VM controller). For example, when the VM controller receives a watchpoint condition (e.g., monitor variable X), but does not receive a value of a watchpoint threshold for the watchpoint condition, then VM controller may select a default value for the watchpoint threshold. For instance, the system profiler may instruct the VM controller to monitor how many times a memory address is called by an application, but the system profiler may not indicate a trigger or threshold (e.g., watchpoint threshold) for monitoring the memory address. Accordingly, the VM controller may select a default value (e.g., default threshold value of 2, 4, 8, 10, 15, 20, 25, 50, 100, etc.). In some cases, the VM controller may provide the watchpoint threshold to the system profiler. Additionally, or alternatively, the watchpoint threshold may be configured by the system profiler (e.g., a context controller of a system profiler). In some cases, the system profiler may provide the watchpoint threshold to the VM controller.

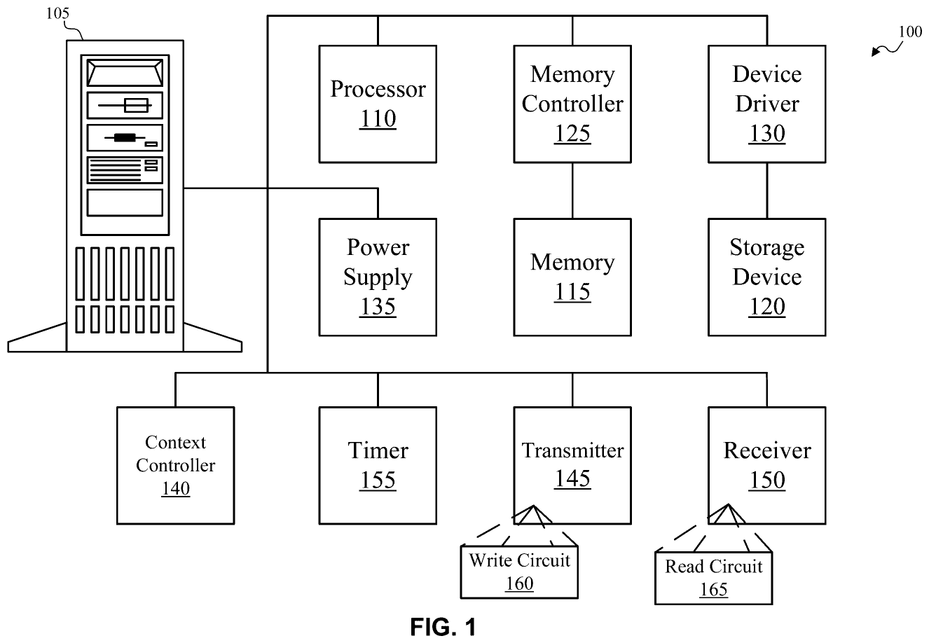

FIG. 1 illustrates an example system 100 in accordance with one or more implementations as described herein. In FIG. 1, machine 105, which may be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI) (SAS) protocol, or a Serial AT Attachment (SATA) protocol. Storage device 120 may include any desired interface, including, for example, a Peripheral Component Interconnect Express (PCIe) interface, or a Compute Express Link (CXL) interface. Storage device 120 may take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may include power supply 135. Power supply 135 may provide power to machine 105 and its components.

Machine 105 may include transmitter 145 and receiver 150. Transmitter 145 or receiver 150 may be respectively used to transmit or receive data. In some cases, transmitter 145 and/or receiver 150 may be used to communicate with memory 115 and/or storage device 120. Transmitter 145 may include write circuit 160, which may be used to write data into storage, such as a register, in memory 115 and/or storage device 120. In a similar manner, receiver 150 may include read circuit 165, which may be used to read data from storage, such as a register, from memory 115 and/or storage device 120. In the illustrated example, machine 105 may include timer 155. Timer 155 may be used to indicate time or time periods associated with executing an application. In some cases, a context switch condition may be based on a time or time period associated with executing an application (e.g., a start time of executing an application, how long an application has been executing, a time between performing a first context switch to performing a second context switch, average time between context switches, etc.).

In one or more examples, machine 105 may be implemented with any type of apparatus. Machine 105 may be configured as (e.g., as a host of) one or more of a server such as a compute server, a storage server, storage node, a network server, a supercomputer, data center system, and/or the like, or any combination thereof. Additionally, or alternatively, machine 105 may be configured as (e.g., as a host of) one or more of a computer such as a workstation, a personal computer, a tablet, a smartphone, and/or the like, or any combination thereof. Machine 105 may be implemented with any type of apparatus that may be configured as a device including, for example, an accelerator device, a storage device, a network device, a memory expansion and/or buffer device, a central processing unit (CPU), a graphics processing unit (GPU), a neural processing unit (NPU), a tensor processing unit (TPU), optical processing units (OPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced extensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, context controller 140 functionality, and/or the like, may be implemented with hardware, software, firmware, or any combination thereof including, for example, hardware and/or software combinational logic, sequential logic, timers, counters, registers, state machines, volatile memories such as at least one of or any combination of the following: dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application specific integrated circuits (ASICs) CPUs including complex instruction set computer (CISC) processors such as x86 processors and/or reduced instruction set computer (RISC) processors such as RISC-V and/or ARM processors), GPUs, NPUs, TPUs, OPUs, and/or the like, executing instructions stored in any type of memory. In some embodiments, one or more components of context controller 140 may be implemented as an SoC.

In some examples, context controller 140 may include any one or combination of logic (e.g., logical circuit), hardware (e.g., processing unit, memory, storage), software, firmware, and the like. In some cases, context controller 140 may perform one or more functions in conjunction with processor 110. In some cases, at least a portion of context controller 140 may be implemented in or by processor 110 and/or memory 115. The one or more logic circuits of context controller 140 may include any one or combination of multiplexers, registers, logic gates, arithmetic logic units (ALUs), cache, computer memory, microprocessors, processing units (CPUs, GPUs, NPUs, and/or TPUs), FPGAs, ASICs, etc., that enable context controller 140 to control context switching based on monitoring virtualized applications.

In one or more examples, context controller 140 may perform one or more operations in conjunction with at least one of a guest kernel, a virtual CPU, a hypervisor, a host CPU, or system profiler (e.g., application profiler, computer architecture simulator, Gem5, etc.). In some implementations, at least a portion of context controller 140 may be implemented or incorporated in at least one of a guest kernel, a virtual CPU, a hypervisor, a host CPU, or a system profiler. In some cases, context controller 140 may pause a virtual processor and context switch to a profiler (e.g. external profiler) when context controller 140 (e.g., in conjunction with a guest kernel) detects the watchpoint under a predefined condition (e.g., detects watchpoint N times). In some cases, context controller 140 may send a request to a guest kernel to instrument watchpoints, and stop and context switch to a system profiler (e.g., external system profiler) when the guest kernel detects the watchpoint N times.

In one or more examples, context controller 140 may save context switching time and/or speed up application execution. In some embodiments, context controller 140 may provide dynamic instrumentation, for example, with hypervisor and/or guest kernel assist to improve system performance. Context controller 140 may provide edge profiling that improves system performance and decreases latency. In some cases, context controller 140 may be configured to work with one or more virtualized applications. Context controller 140 may enable a user to implement one or more (e.g., unlimited) breakpoints and/or watchpoints. In some cases, context controller 140 may perform operations with virtualized applications, for example, by using dynamic instrumentation support from a hypervisor and/or a guest kernel.

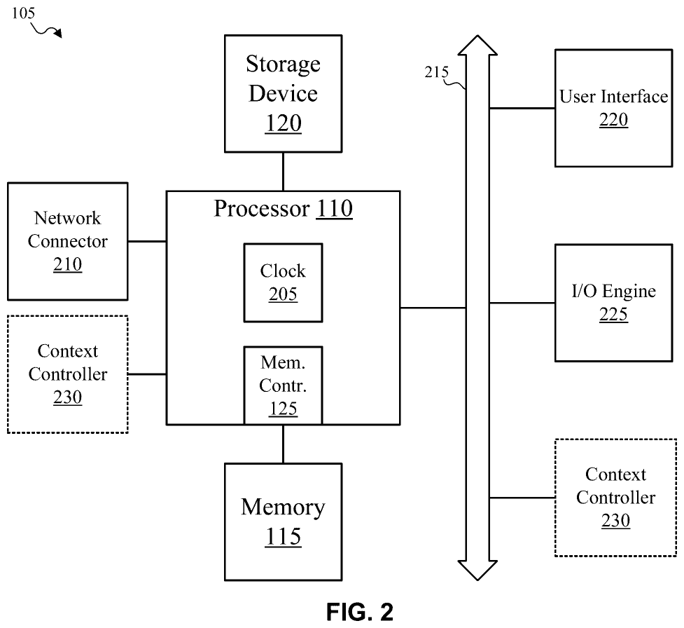

FIG. 2 illustrates details of machine 105 of FIG. 1, according to examples described herein. In the illustrated example, machine 105 may include one or more processors 110, which may include memory controllers 125 and clocks 205, which may be used to coordinate the operations of the components of the machine. Processors 110 may be coupled to memories 115, which may include random access memory (RAM), read-only memory (ROM), or other state preserving media, as examples. Processors 110 may be coupled to storage devices 120, and to network connector 210, which may be, for example, an Ethernet connector or a wireless connector. Processors 110 may be connected to buses 215, to which may be attached user interfaces 220 and Input/Output (I/O) interface ports that may be managed using I/O engines 225, among other components. As shown, processors 110 may be coupled to context controller 230, which may be an example of context controller 140 of FIG. 1. Additionally, or alternatively, processors 110 may be connected to buses 215, to which may be attached context controller 230.

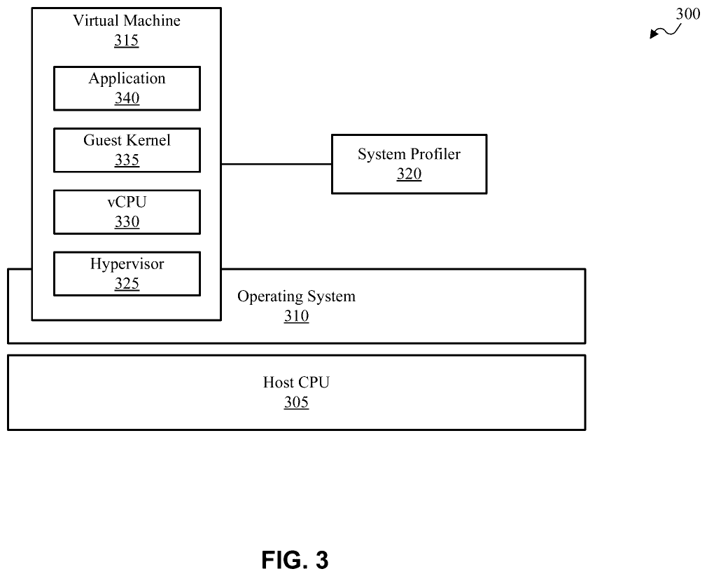

FIG. 3 illustrates an example system 300 in accordance with one or more implementations as described herein. System 300 may be configured to perform one or more operations to control context switching based on monitoring virtualized applications. In some cases, system 300 may perform one or more operations in conjunction with a context controller (e.g., context controller 140, context controller 230).

In the illustrated example, system 300 may include at least one host CPU (e.g., host CPU 305), operating system 310, virtual machine 315, and system profiler 320. As shown, virtual machine 315 includes hypervisor 325, virtual CPU (vCPU) 330, guest kernel 335, and application 340. In some cases, system 300 includes a host system that includes host storage (e.g., host storage devices, host SSDs, etc.), host memory (e.g., DRAM), and one or more host CPUs (e.g., host CPU 305). In some cases, operations of virtual machine 315 and/or system profiler 320 are executed in conjunction with operating system 310 and/or executed by host CPU 305. In some cases, at least a portion of the processing capability of host CPU 305 may be allocated to virtual machine 315 (e.g., to vCPU 330).

In one or more examples, system profiler 320 may load a watchpoint condition. For example, system profiler 320 may load the watchpoint condition in application 340. In some examples, guest kernel 335 and/or hypervisor 325 may receive one or more messages from system profiler 320. In some cases, guest kernel 335 and/or hypervisor 325 may receive a watchpoint condition from system profiler 320 (e.g., via the one or more messages). In some cases, the watchpoint condition may correspond to application 340. In some implementations, application 340 may be a virtual application configured to execute on virtual machine 315.

In some examples, guest kernel 335 may receive a pathname of application 340 from the system profiler. In some cases, guest kernel 335 may be configured to monitor application 340 based on the watchpoint condition. In some cases, system profiler 320 may give guest kernel 335 and/or hypervisor 325 control of application 340 (e.g., control to execute application 340, to pause execution of application 340, to transfer control of application 340, etc.). Additionally, or alternatively, system profiler 320 may give guest kernel 335 and/or hypervisor 325 control of virtual machine 315 and/or vCPU 330. Guest kernel 335 and/or hypervisor 325 may execute application 340 based on receiving the pathname and/or based on receiving the watchpoint condition. In some cases, system profiler 320 may instruct guest kernel 335 and/or hypervisor 325 to execute application 340. In some cases, the pathname may include an absolute pathname that may include a root element (e.g., root directory of operating system 310, root directory of system 300) and a complete directory list to enable guest kernel 335 to find an executable of application 340 (e.g., root/applications/application.exe). In some cases, the pathname may include a relative pathname that may be provided to specify a pathname in a current directory or default directory. For example, root/applications may be a current directory or default directly, and system profile 320 may provide the pathname “applications/application.exe” or “/application.exe” to guest kernel 335. In some examples, the pathname may be based on a uniform resource locator (URL) of the Internet or a cloud computing system. For example, system profile 320 may provide guest kernel 334 the URL http://example.com/applications/application.exe.

In one or more examples, guest kernel 335 and/or hypervisor 325 may determine a number of times the watchpoint condition is detected based on implementing the watchpoint condition on application 340 and executing application 340. In some cases, guest kernel 335 and/or hypervisor 325 may monitor application 340 to determine whether the watchpoint condition is satisfied. For example, guest kernel 335 and/or hypervisor 325 may determine whether the number of times the watchpoint condition is detected satisfies a watchpoint threshold. In some cases, guest kernel 335 and/or hypervisor 325 may receive a value of the watchpoint threshold from system profiler 320. For example, a message from system profiler 320 may include the watchpoint condition and/or the watchpoint threshold. Additionally, or alternatively, guest kernel 335 and/or hypervisor 325 may determine or set a value of the watchpoint threshold based on receiving the watchpoint condition from system profiler 320.

When guest kernel 335 and/or hypervisor 325 determines that the watchpoint threshold is satisfied, guest kernel 335 and/or hypervisor 325 may pause execution of application 340. For example, guest kernel 335 and/or hypervisor 325 may allow a context switch of application 340 to system profiler 320 when guest kernel 335 and/or hypervisor 325 determines the watchpoint condition occurred N times, where N is a positive integer (e.g., 2, 4, 8, 10, 15, 20, 25, 50, 100, etc.). In some cases, when guest kernel 335 and/or hypervisor 325 determines that the watchpoint threshold is satisfied, guest kernel 335 and/or hypervisor 325 gives control of application 340 to system profiler 320.

In some examples, operating system 310, virtual machine 315, and/or system profiler 320 may execute on a host system (e.g., system 300). For example, operating system 310, virtual machine 315, and/or system profiler 320 may be executed by host CPU 305. In some cases, operating system 310 may include a Linux operating system. In some cases, virtual machine 315 includes system profiler 320 (e.g., system profiler 320 is a component of virtual machine 315). In some cases, system profiler 320 includes virtual machine 315 (e.g., virtual machine 315 is a component of system profiler 320). In some cases, system profiler 320 may include an application profiler, a computer architecture simulator (e.g., Gem5, ZSim, PTLsim, etc.), a CPU simulation framework, a memory timing simulator, and/or an event-driven simulator. In some cases, a guest operating system of virtual machine 315 may be running in a virtualized environment of system profiler 320 (e.g., virtual machine 315), and application 340 may be executed in the guest operating system. In some cases, operating system 310 may include the guest operating system.

In some examples, guest kernel 335 executing application 340 may be based on guest kernel 335 receiving from system profiler 320 control of application 340, control of a guest operating system in which application 340 executes, and/or control of virtual machine 315. In some cases, guest kernel 335 may configure application 340 as an instrumented application based on guest kernel 335 receiving the watchpoint condition from system profiler 320. In some cases, guest kernel 335 executing application 340 may include guest kernel 335 executing a virtualized application (e.g., application 340) on virtual machine 315, where hypervisor 325 and/or system profiler 320 create virtual machine 315.

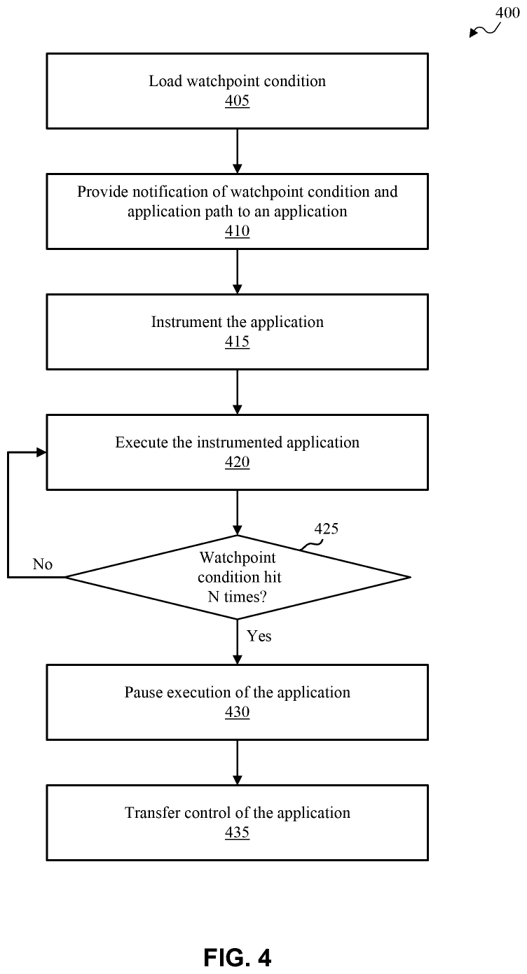

FIG. 4 depicts a flow diagram illustrating an example method 400 associated with the disclosed systems, in accordance with example implementations described herein. In some configurations, method 400 may be implemented by context controller 140 of FIG. 1 and/or context controller 230 of FIG. 2. In some configurations, method 400 may be implemented in conjunction with machine 105, components of machine 105, system 300, component of system 300, or any combination thereof. The depicted method 400 is just one implementation and one or more operations of method 400 may be rearranged, reordered, omitted, and/or otherwise modified such that other implementations are possible and contemplated.

At 405, method 400 may include loading a watchpoint. For example, system profiler 320 may load or implement a watchpoint condition (e.g., load the watchpoint condition in application 340). In some cases, the watchpoint condition may include a threshold (e.g., a watchpoint threshold). At 410, method 400 may include providing notification of the watchpoint condition and providing an application path to the application. For example, system profiler 320 may notify guest kernel 335 and/or hypervisor 325 of the watchpoint condition. In some cases, system profiler 320 may provide guest kernel 335 and/or hypervisor 325 with an application path to application 340.

At 415, method 400 may include instrumenting the application. For example, guest kernel 335 may identify application 340 based on a pathname provided by system profiler 320. Guest kernel 335 may instrument application 340 based on receiving the watchpoint condition from system profiler 320.

At 420, method 400 may include executing the instrumented application. For example, guest kernel 335 may execute an instrumented version of application 340 based on the watchpoint condition.

At 425, method 400 may include determining whether the watchpoint condition is satisfied (e.g., is encountered N times). For example, guest kernel 335 may determine whether a watchpoint threshold is satisfied in relation to the watchpoint condition. As shown, when guest kernel 335 determines the watchpoint threshold is not satisfied, method 400 may include guest kernel 335 continuing to execute application 340.

At 430, method 400 may include pausing execution of the application. For example, when guest kernel 335 determines the watchpoint threshold is satisfied (e.g., watchpoint condition encountered at least N times, watchpoint condition encountered more than N times), method 400 may include guest kernel 335 pausing execution of application 340.

In some cases, the watchpoint condition may be based on a value of a variable changing based on execution of application 340. When guest kernel 335 determines that the value of the variable changes N times (e.g., satisfying a watchpoint threshold based on N), then guest kernel 335 may pause execution of application 340. In some examples, when guest kernel 335 determines that the value of the variable equals a set value or that the variable is changed to equal the set value N times, then guest kernel 335 may pause execution of application 340. For example, the watchpoint condition provided by system profiler 320 may indicate the variable (e.g., variable name), the variable value that triggers guest kernel 335 to pause execution of application 340, and/or the watchpoint threshold value N, etc. In some implementations, the watchpoint condition may be based on the address of a data access that is to be monitored by guest kernel 335. For example, watchpoint condition may indicate the address of a data access and/or may indicate a value of the watchpoint threshold N associated with the address of the data access. When guest kernel 335 determines that the address of the data access is called at least N times (e.g., based on write operation, read operation, and/or modify operation), guest kernel 335 may determine that the watchpoint threshold is satisfied (e.g., number of times the address of the data access is called is greater than N, or equal to or greater than N), and as a result, guest kernel 335 may pause execution of application 340. In some cases, the watchpoint condition may be based on a variable being monitored. When guest kernel 335 determines that the value of the variable is called at least N times, guest kernel 335 may determine that the watchpoint threshold is satisfied (e.g., number of times the variable is called is greater than N, or equal to or greater than N), and as a result, guest kernel 335 may pause execution of application 340.

At 435, method 400 may include transferring control of the application. For example, guest kernel 335 may transfer control of application 340 to system profiler 320 based on guest kernel 335 determining the watchpoint threshold is satisfied.

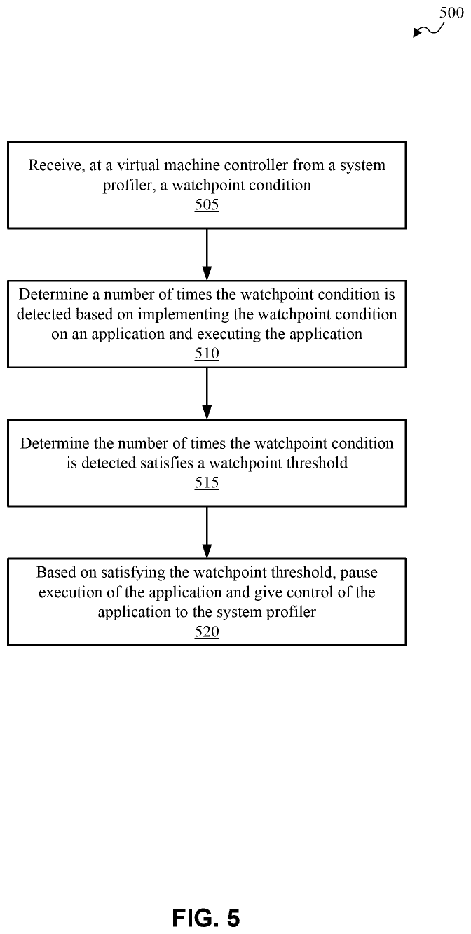

FIG. 5 depicts a flow diagram illustrating an example method 500 associated with the disclosed systems, in accordance with example implementations described herein. In some configurations, method 500 may be implemented by context controller 140 of FIG. 1 and/or context controller 230 of FIG. 2. In some configurations, method 500 may be implemented in conjunction with machine 105, components of machine 105, system 300, component of system 300, or any combination thereof. The depicted method 500 is just one implementation and one or more operations of method 500 may be rearranged, reordered, omitted, and/or otherwise modified such that other implementations are possible and contemplated.

At 505, method 500 may include receiving, at a virtual machine controller from a system profiler, a watchpoint condition. For example, guest kernel 335 and/or hypervisor 325 may receive, from system profiler 320, a watchpoint condition or notification of the watchpoint condition associated with application 340. In some cases, the watchpoint condition may include a threshold (e.g., watchpoint threshold). For example, in some cases, the watchpoint condition may indicate a number of times the watchpoint condition is to be encountered before pausing execution of application 340.

At 510, method 500 may include determining a number of times the watchpoint condition is detected based on implementing the watchpoint condition on an application and executing the application. For example, guest kernel 335 and/or hypervisor 325 may determine a number of times the watchpoint condition is detected based on implementing the watchpoint condition on application 340 and executing application 340.

At 515, method 500 may include determining the number of times the watchpoint condition is detected satisfies a watchpoint threshold. For example, guest kernel 335 and/or hypervisor 325 may determine whether the number of times the watchpoint condition is detected satisfies a watchpoint threshold.

At 520, method 500 may include, based on satisfying the watchpoint threshold, pausing execution of the application and giving control of the application to the system profiler. For example, guest kernel 335 and/or hypervisor 325 may determine the number of times the watchpoint condition is detected does satisfy the watchpoint threshold. Based on determining the number of times the watchpoint condition is detected does satisfy the watchpoint threshold, guest kernel 335 and/or hypervisor 325 may pause execution of application 340 and give control of application 340 to system profiler 320.

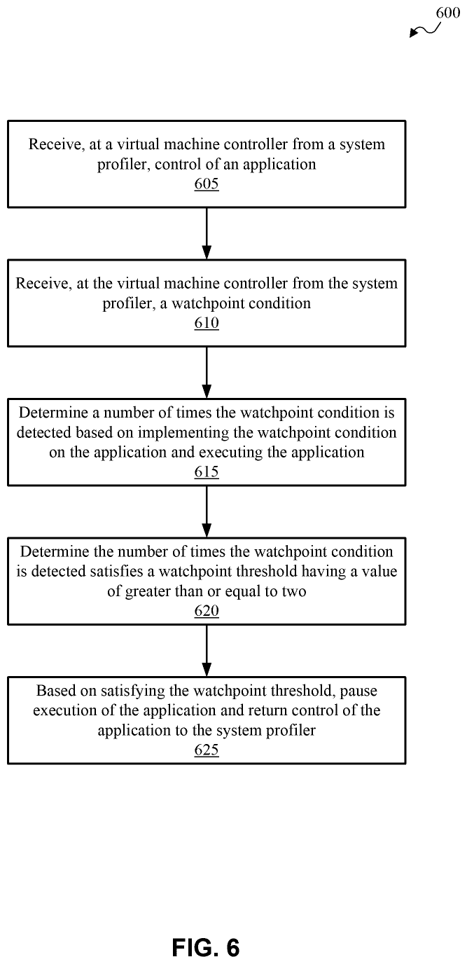

FIG. 6 depicts a flow diagram illustrating an example method 600 associated with the disclosed systems, in accordance with example implementations described herein. In some configurations, method 600 may be implemented by context controller 140 of FIG. 1 and/or context controller 230 of FIG. 2. In some configurations, method 600 may be implemented in conjunction with machine 105, components of machine 105, system 300, component of system 300, or any combination thereof. The depicted method 600 is just one implementation and one or more operations of method 600 may be rearranged, reordered, omitted, and/or otherwise modified such that other implementations are possible and contemplated.

At 605, method 600 may include receiving, at a virtual machine controller from a system profiler, control of an application. For example, guest kernel 335 and/or hypervisor 325 may receive control of application 340 from system profiler 320. Additionally, or alternatively, guest kernel 335 and/or hypervisor 325 may receive a pathname of application 340 from system profiler 320.

At 610, method 600 may include receiving, at the virtual machine controller from the system profiler, a watchpoint condition. For example, guest kernel 335 and/or hypervisor 325 may receive, from system profiler 320, a watchpoint condition or notification of the watchpoint condition associated with application 340. In some cases, the watchpoint condition may include a threshold (e.g., watchpoint threshold). For example, in some cases, the watchpoint condition may indicate a number of times the watchpoint condition is to be encountered before pausing execution of application 340.

At 615, method 600 may include determining a number of times the watchpoint condition is detected based on implementing the watchpoint condition on an application and executing the application. For example, guest kernel 335 and/or hypervisor 325 may determine a number of times the watchpoint condition is detected based on implementing the watchpoint condition on application 340 and executing application 340.

At 620, method 600 may include determining the number of times the watchpoint condition is detected satisfies a watchpoint threshold having a value of greater than or equal to two. For example, guest kernel 335 and/or hypervisor 325 may determine whether the number of times the watchpoint condition is detected satisfies a watchpoint threshold.

At 625, method 600 may include based on satisfying the watchpoint threshold, pausing execution of the application and giving control of the application to the system profiler. For example, guest kernel 335 and/or hypervisor 325 may determine the number of times the watchpoint condition is detected does satisfy the watchpoint threshold. Based on determining the number of times the watchpoint condition is detected does satisfy the watchpoint threshold, guest kernel 335 and/or hypervisor 325 may pause execution of application 340 and return control of application 340 to system profiler 320.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example, a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples described herein set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method comprising:
receiving, at a virtual machine controller and from a system profiler, a watchpoint condition;
determining a number of times the watchpoint condition is detected based on implementing the watchpoint condition on an application and executing the application;
determining the number of times the watchpoint condition is detected satisfies a watchpoint threshold having a value of greater than or equal to two; and
based on satisfying the watchpoint threshold, pausing execution of the application and giving control of the application to the system profiler.

2. The method of claim 1, further comprising receiving from the system profiler a pathname of the application, wherein executing the application is based on receiving the pathname of the application.

3. The method of claim 1, further comprising receiving a value of the watchpoint threshold from the system profiler.

4. The method of claim 1, further comprising setting a value of the watchpoint threshold to a default value based on receiving the watchpoint condition from the system profiler.

5. The method of claim 1, wherein executing the application is based on receiving control of the application from the system profiler.

6. The method of claim 1, wherein the virtual machine controller comprises at least one of a kernel or a hypervisor.

7. The method of claim 6, wherein the kernel comprises a guest kernel of a virtual machine.

8. The method of claim 1, wherein executing the application comprises executing a virtualized application on a virtual machine, the virtual machine being created by the virtual machine controller.

9. The method of claim 8, wherein the system profiler comprises a computer architecture simulator that executes on a host system of the virtual machine.

10. A device comprising:
at least one memory; and
at least one processor coupled with the at least one memory configured to:
receive, at a virtual machine controller of the device and from a system profiler, a watchpoint condition;
determine a number of times the watchpoint condition is detected based on implementing the watchpoint condition on an application and executing the application;
determine the number of times the watchpoint condition is detected satisfies a watchpoint threshold having a value of greater than or equal to two; and
based on satisfying the watchpoint threshold, pause execution of the application and give control of the application to the system profiler.

11. The device of claim 10, wherein the at least one processor is configured to receive from the system profiler a pathname of the application, wherein executing the application is based on receiving the pathname of the application.

12. The device of claim 10, wherein the at least one processor is configured to receive a value of the watchpoint threshold from the system profiler.

13. The device of claim 10, wherein the at least one processor is configured to set a value of the watchpoint threshold to a default value based on receiving the watchpoint condition from the system profiler.

14. The device of claim 10, wherein executing the application is based on receiving control of the application from the system profiler.

15. The device of claim 10, wherein the virtual machine controller comprises at least one of a kernel or a hypervisor.

16. The device of claim 15, wherein the kernel comprises a guest kernel of a virtual machine.

17. A non-transitory computer-readable medium storing code that comprises instructions executable by a processor to:
receive, at a virtual machine controller and from a system profiler, a watchpoint condition;
determine a number of times the watchpoint condition is detected based on implementing the watchpoint condition on an application and executing the application;
determine the number of times the watchpoint condition is detected satisfies a watchpoint threshold having a value of greater than or equal to two; and
based on satisfying the watchpoint threshold, pause execution of the application and give control of the application to the system profiler.

18. The non-transitory computer-readable medium of claim 17, wherein the code includes further instructions executable by the processor to cause the processor to receive from the system profiler a pathname of the application, wherein executing the application is based on receiving the pathname of the application.

19. The non-transitory computer-readable medium of claim 17, wherein the code includes further instructions executable by the processor to cause the processor to receive a value of the watchpoint threshold from the system profiler.

20. The non-transitory computer-readable medium of claim 17, wherein the code includes further instructions executable by the processor to cause the processor to set a value of the watchpoint threshold to a default value based on receiving the watchpoint condition from the system profiler.
